(19) United States
(12) Patent Application Publication
(10) Pub. No.: US 2015/0108690 A1
(43) Pub. Date: Apr. 23, 2015

(54) SHEET DIE APPARATUS WITH DIRECT EXTRUDER INTERFACE AND ASSOCIATED METHODS

(71) Applicant: D AND D MANUFACTURING, Merritt Island, FL (US)

(72) Inventors: Dale POLK, JR., Merritt Island, FL (US); Timothy A. POLK, Titusville, FL (US)

(21) Appl. No.: 14/519,689

(22) Filed: Oct. 21, 2014

Related U.S. Application Data
(60) Provisional application No. 61/894,110, filed on Oct. 22, 2013.

(51) Int. Cl. B29D 7/01; B29C 39/10

(52) U.S. Cl. CPC B29D 7/01; B29C 39/10
USPC 264/319; 425/112

(57) ABSTRACT

A sheet die apparatus includes an extruder with an auger configured to provide a molten composite material. A sheet die has an opening to receive the auger, and a chamber therein to receive the molten composite material so as to form a sheet.

### RELATED APPLICATION

This application claims the benefit of U.S. Provisional Application Ser. No. 61/894,110 filed Oct. 22, 2013, the entire contents of which are incorporated herein by reference,

### FIELD OF THE INVENTION

The present invention relates to the field of plastic molding, and, more particularly, to a sheet die apparatus and related methods.

### BACKGROUND OF THE INVENTION

Composites are materials formed from a mixture of two or more components that produce a material with properties or characteristics that are superior to those of the individual materials. Most composites comprise two parts, a matrix component and one or more reinforcement components.

Matrix components are the materials that bind the composite together and they are usually less stiff than the reinforcement components. These materials are shaped under pressure at elevated temperatures. The matrix encapsulates the reinforcements in place and distributes the load among the reinforcements. Since reinforcements are usually stiffer than the matrix material, they are the primary load-carrying component within the composite. Reinforcements may come in many different forms ranging from fibers, to fabrics, to particles or rods imbedded into the matrix that form the composite.

There are many different types of composites, including plastic composites. Each plastic resin has its own unique properties, which when combined with different reinforcements create composites with different mechanical and physical properties. Plastic composites are classified within two primary categories: thermoset and thermoplastic composites.

Thermoset composites use thermoset resins as the matrix material. After application of heat and pressure, thermoset resins undergo a chemical change, which cross-links the molecular structure of the material. Once cured, a thermoset part cannot be remolded. Thermoset plastics resist higher temperatures and provide greater dimensional stability than most thermoplastics because of the tightly cross-linked structure found in thermoset plastic. Thermoplastic matrix components are not as constrained as thermoset materials and can be recycled and reshaped to create a new part.

Common matrix components for thermoplastic composites include polypropylene (PP), polyethylene (PE), polyetheretherketone (PEEK) and nylon. Thermoplastics that are reinforced with high-strength, high-modulus fibers to form thermoplastic composites provide dramatic increases in strength and stiffness, as well as toughness and dimensional stability.

Compression molding and injection molding are not readily capable of producing a thermoplastic composite reinforced with long fibers (i.e., greater than about 12 millimeters) that remain largely unbroken during the molding process itself. This is especially true for the production of large and more complex parts.

A three-step process may be utilized to mold such a part: (1) third party compounding of a pre-preg composite formulation; (2) preheating of pre-preg material in an oven, and, (3) insertion of molten material in a mold to form a desired part. This process has several disadvantages that limit the industry's versatility for producing more complex, large parts with sufficient structural reinforcement. One disadvantage is that the sheet-molding process cannot readily produce a part of varying thickness, or parts requiring a deep draw of thermoplastic composite material. The thicker the extruded sheet, the more difficult it is to re-melt the sheet uniformly through its thickness to avoid problems associated with the structural formation of the final part.

One approach to varying the thickness of an extruded material is disclosed in U.S. published patent application no. 2013/0193611 to Polk, which is incorporated herein by reference in its entirety. Polk discloses an apparatus that utilizes a dual trolley mold transport system to vary the thickness of the extruded material. The mold transport assembly rides on a first movable structure in the x direction (first trolley) and on a second movable structure in the y direction (second trolley). The combination of being able to control both x and y direction movement by use of one trolley riding on the other gives control of the x-y plane.

With respect to sheet dies, there is typically a transition pipe between the extruder and the sheet die. A length of the transition pipe may be 10-20 feet, for example. A problem arises with extruded material remaining in the transition pipe after having been output from the extruder. When the next batch of molten material is run through the extruder, any material remaining in the transition pipe has to be pushed out through the sheet die. This requires a large amount of torque. Moreover, the molten material can be degraded if it is sheered within the transition pipe as a result of the excess torque.

### SUMMARY OF THE INVENTION

In view of the foregoing background, it is therefore an object of the present invention to improve upon the process of delivering molten material between an extruder and a sheet die.

This and other objects, advantages and features in accordance with the present invention are provided by a sheet die apparatus comprising an extruder comprising an auger configured to provide a molten composite material, and a sheet die. The sheet die may have an opening to receive the auger, and a chamber therein to receive the molten composite material so as to form a sheet. The sheet die apparatus advantageously does away with the need for a transition pipe that is typically positioned between the extruder and the sheet die. This allows the sheet die to be easily cleaned.

The extruder may comprise a barrel enclosing a middle portion of the auger, with an end portion of the auger extending outwards from the barrel and within the opening of the sheet die. The barrel may directly contact the sheet die.

The sheet die may include a passageway extending between the auger and the chamber for directing the molten composite material. The molten composite material may be gravity deposited through the passageway to the chamber. An end of the auger may be positioned within the passageway. Alternatively, the sheet die may further comprise a passageway auger within the passageway to push the molten composite material to the chamber.

The sheet die may further comprise at least one adjustable deckle for changing a width of the chamber. The sheet die may include a passageway between the auger and the chamber. The at least one adjustable deckle may comprise a pair of adjustable deckles for changing the width of the chamber to be aligned with a width of the passageway. The passageway may be centered within the chamber.

Another advantage of the sheet die apparatus is that once the extruder is turned off, the adjustable deckles may be moved toward the center of the chamber to push out any extruded material that may remain in the chamber.

The molten composite material may comprise a matrix component and at least one reinforcement component. The molten composite material may comprise a molten plastic composite. The molten plastic composite may comprise a thermoset composite or a thermoplastic composite.

### BRIEF DESCRIPTION OF THE DRAWINGS

FIG. 1 is an overview of a plastic molding apparatus with an extruder having an adjustable barrel in accordance with the present invention.

FIG. 2 is side perspective view of the extruder with the adjustable barrel shown in FIG. 1.

FIG. 3 is top view of the extruder shown in FIG. 1 with the adjustable barrel in an extended position.

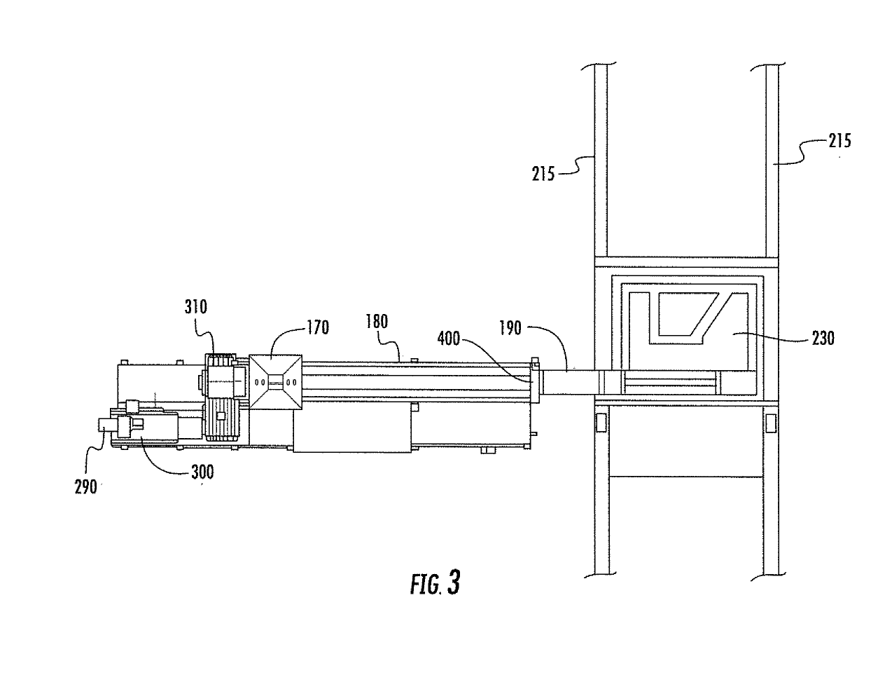

FIG. 4 is a cross-sectional view of the adjustable barrel shown in FIG. 3.

FIG. 5 is top view of the extruder shown in FIG. 1 with the adjustable barrel in a retracted position.

FIG. 6 is a cross-sectional view of the adjustable barrel shown in FIG. 5.

FIG. 7 is a cross-sectional side perspective view of a sheet die apparatus with a direct extruder interface in accordance with the present invention.

FIG. 8 is a cross-sectional side perspective view of another embodiment of the sheet die apparatus illustrated in FIG. 7.

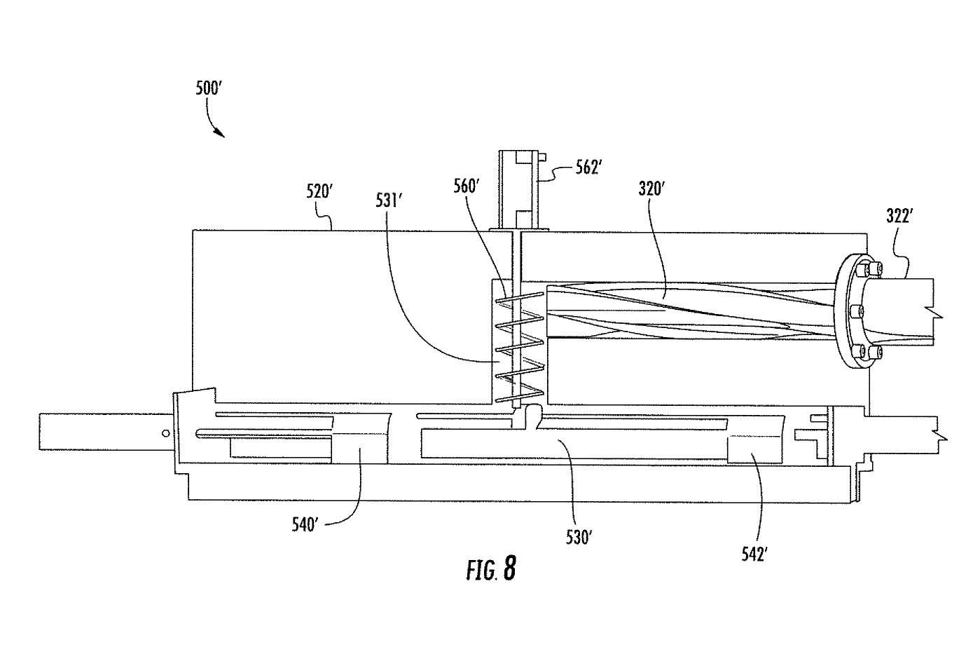

FIG. 9 is a flowchart illustrating a method for using a sheet die apparatus to form a sheet in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

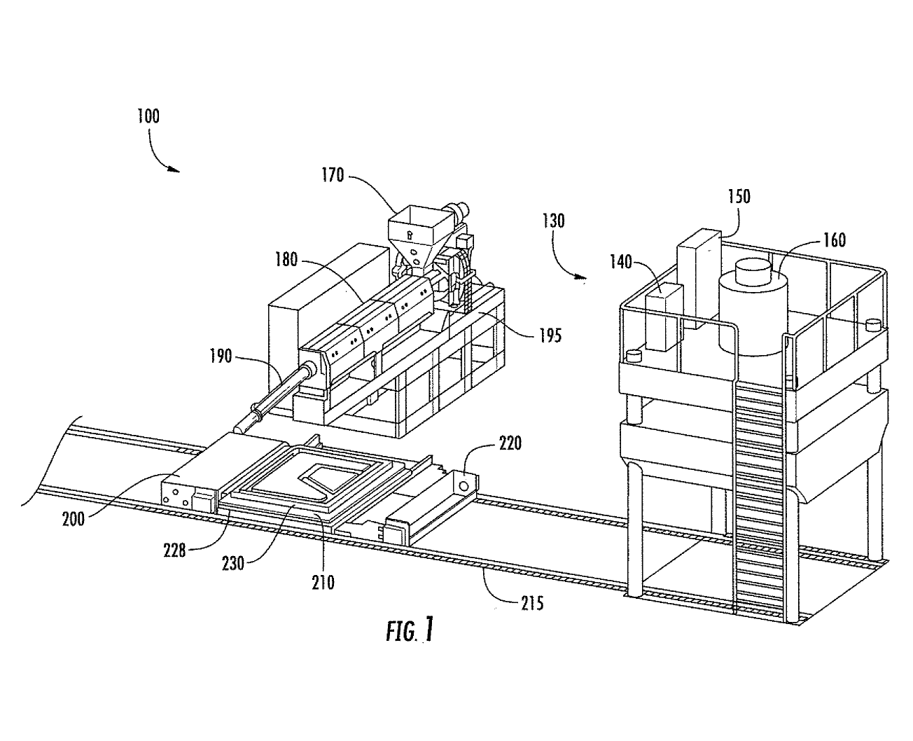

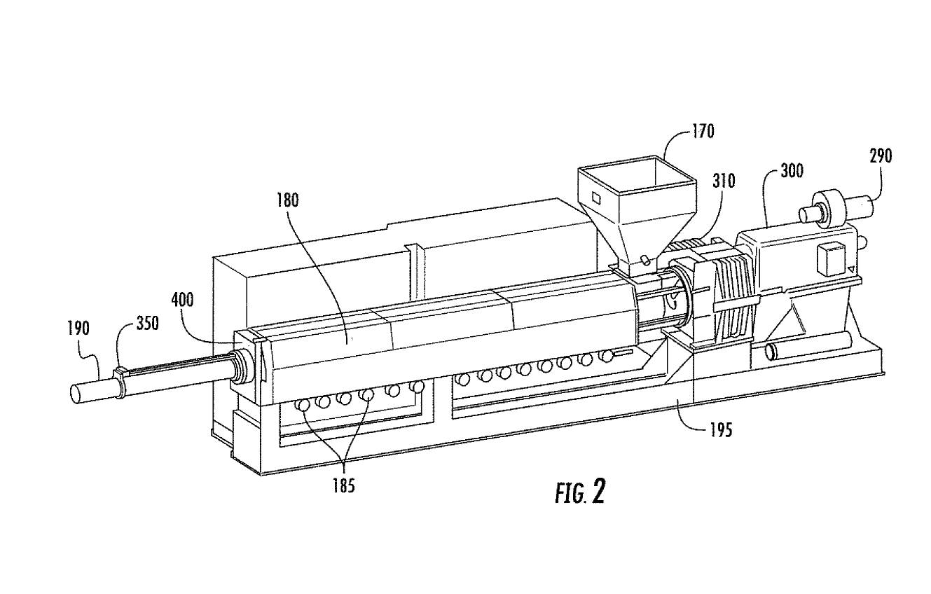

Referring initially to FIGS. 1 and 2, an embodiment of the illustrated plastic molding device 100 will now be discussed. A mold base 210 is located directly below an adjustable extension barrel 190 coupled to an extruder 180. As will be discussed in greater detail below, the adjustable extension barrel 190 is moveable between an extended position and a retracted position. The extruder 180 is supported by an injection barrel frame 195. Positioned on the mold base 210 is a lower compression mold 230 for accepting molten plastic composite material in preparation for molding.

The illustrated plastic molding device 100 includes a single press 130. However, alternate embodiments can operate with two presses. The press 130 contains an upper mold required for compression molding of the parts. The press 130 has a hydraulic ram 160 for applying compressive force as well as two control cabinets 140, 150. The lower compression mold 230 rides on a movable structure 228 that rides on a pair of spaced apart rails 215. The movable structure 228 may also be referred to as a trolley. The trolley 228 can move back and back and forth below the adjustable extension barrel 190 in an x-direction that is parallel to the rails 215. The trolley 228 is interfaced between a mold carrier device 200 and a wheel block support 220 that provide a drive mechanism for moving the trolley. The moveable structure is not limited to trolley and rail configuration. Other configurations for moving the lower mold are readily acceptable.

To achieve control of material deposition in the y-direction (perpendicular to the rails 215), the adjustable extension barrel 190 is moveable between an extended position and a retracted position. The adjustable extension barrel 190 avoids the need for a second trolley as required in the above-referenced Polk application (U.S. published patent application no. 2013/0193611). The adjustable extension barrel 190 simplifies deposition of the extruded material in the y-direction.

The combination of being able to control the x-direction with the trolley and the y-direction with the adjustable extension barrel 190 gives control of the x-y plane. When this is combined with the ability to control the volumetric flow of molten composite material emanating from the adjustable extension barrel 190, this gives in effect 3-axis control and the capability to create “near net shape” parts on the lower compression mold 230 before the upper mold is applied for compression.

A material feed hopper 170 accepts polymeric resin or composite material into an auger or screw section where heaters are heating the polymeric material to a molten state while the auger or screw 320 is feeding it along the length of the adjustable barrel 190. A screw motor 300 with a cooling fan 290 drives a hydraulic injection unit 310.

Heaters 185 along the injection barrel maintain temperature control. The molten composite material is fed from a drop point 340 of the adjustable extension barrel 190 onto the lower compression mold 230.

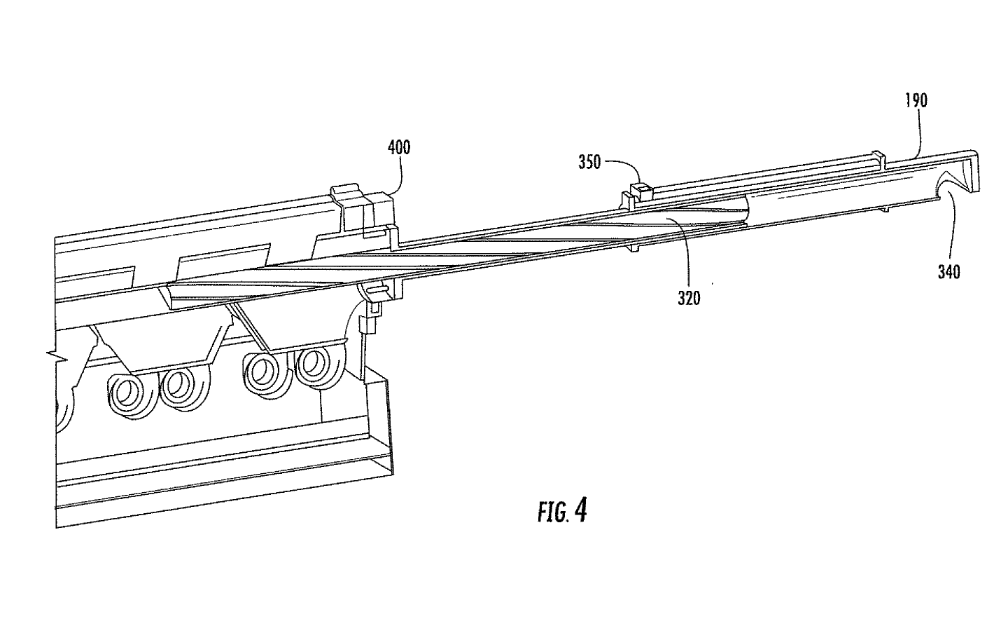

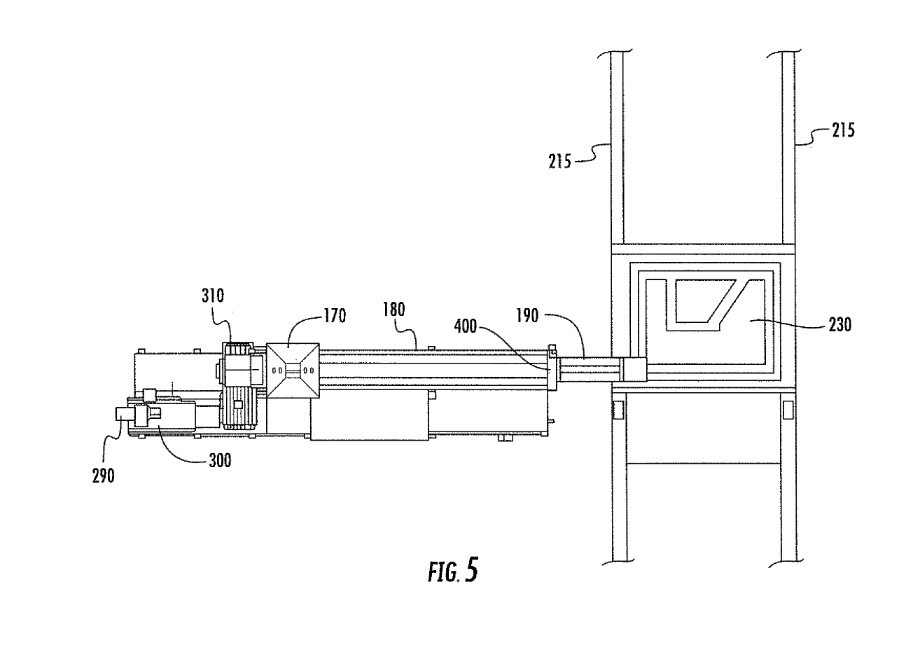

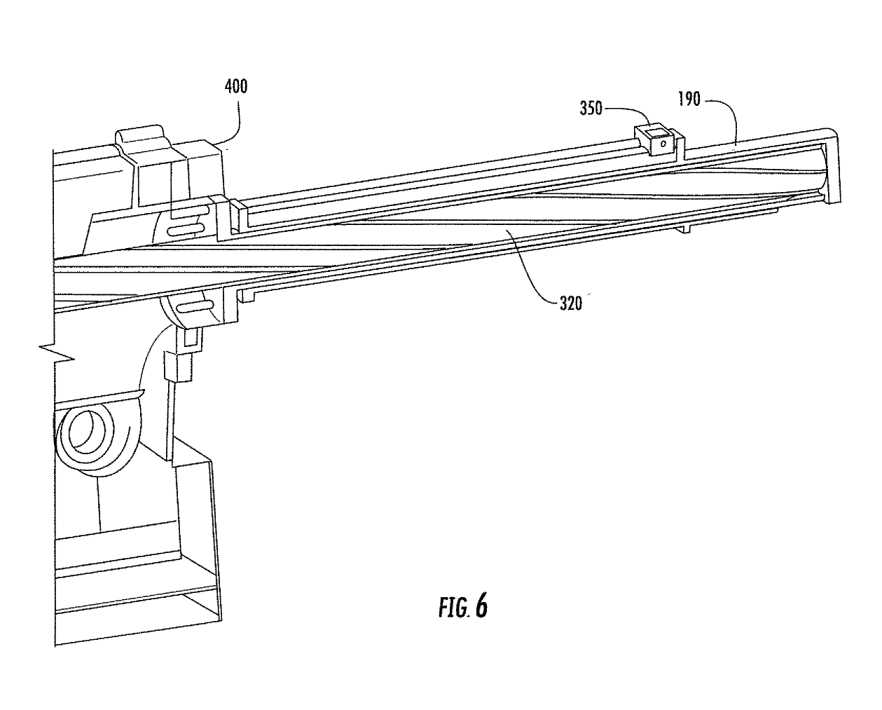

As illustrated in FIGS. 4 and 5, the adjustable extension barrel 190 is in a fully extended position. As the screw or auger 320 rotates, the molten composite material is pushed toward the drop point 340. As illustrated in FIGS. 5 and 6, the adjustable extension barrel 190 is in a fully retracted position. As the auger 320 rotates, the molten composite material exits the drop point 340.

An advantage of the adjustable extension barrel 190 in the fully retracted position is that molten composite material will not remain in the barrel since there is no gap between the auger 320 and the drop point 340. For example, if 150 pounds of material was placed in the hopper 170, then the operator will know that 150 pounds of material will exit the drop point 340, particularly when the adjustable extension barrel 190 is in the fully retracted position. For color changes in the molten composite material, this avoids an overlap of parts with different colors then as initially intended.

Actuators 350 control movement of the adjustable extension barrel 190 between the retracted and extended positions. A controller 400 controls movement of the adjustable extension barrel 190 in the y-direction. This is done in coordination with movement of the lower compression mold 230 in the x-direction.

The lower half of the matched-mold discretely moves in space and time at varying speeds and in a back and fourth movement in the x-direction. Likewise, the drop point 340 of the adjustable barrel 190 discretely moves in space and time at varying speeds and in a back and fourth movement but in the y-direction. This enables the deposit of material precisely and more thickly at slow speed and more thinly at faster speeds.

Although not illustrated, a deposition tool may be coupled to a drop point 340 for feeding the molten composite material precisely onto the lower compression mold 230. It should be noted that the deposition tool in some embodiments could be as simple as a straight pipe acting as an injection nozzle but could also be a sheet die.

The combination of x-y control of the lower compression mold 230 and the adjustable extension barrel 190 and control of the volumetric flow rate of the molten material allows precise deposition of the molten composite material into the desired location in the lower compression mold 230 so that a “near net shape” of the molded part is created. This includes sufficient molten material deposited in locations with deeper cavities in the lower mold. Upon completion of the “near net shape” molten deposition of the composite material, the filled half of the matched mold is mechanically transferred by the trolley 228 along the rails 215 to the compression press 130 for final consolidation of the molded part.

Since the filled half of the mold represents a “near net shape” of the final molded part, the final compression molding step with the other half of the matched mold can be accomplished at very low pressures (<2000 psi) and with minimal movement of the molten composite mixture.

The extrusion-molding process thus includes a computer-controlled extrusion system that integrates and automates material blending or compounding of the matrix and reinforcement components to dispense a profiled quantity of molten composite material that gravitates into the lower half of a matched-mold from the adjustable extension barrel 190, the movements of which are controlled while receiving the material. The compression molding station 130 receives the lower half of the mold 230 for pressing the upper half of the mold against the lower half to form the desired structure or part.

The lower half of the matched-mold discretely moves in space and time at varying speeds and in a back and fourth movement in the x-direction (i.e., first direction). Likewise, the drop point 340 of the adjustable barrel 190 discretely moves in space and time at varying speeds and in a back and fourth movement but in the y-direction (i.e., second direction). This enables the deposit of material precisely and more thickly at slow speed and more thinly at faster speeds.

Unprocessed resin (which may be any form of regrind or pleated thermoplastic or, optionally, a thermoset epoxy) is the matrix component fed into a feeder or hopper of the injection head, along with reinforcement fibers greater than about 12 millimeters in length. The composite material 240 may be blended and/or compounded by the adjustable barrel 190, and “intelligently” deposited onto the lower mold half 230 by controlling the output of the adjustable barrel 190 and the movement of the lower mold half 230 in the x-direction and movement of the adjustable extension barrel in the y-direction. The lower section of the matched-mold receives precise amounts of extruded composite material, and is then moved into the compression molding station.

The software and computer controllers needed to carry out this computer control encompass many known in the art. Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry out the illustrated embodiment may be a stand-alone application, network based, or wired or wireless Internet based to allow easy, remote access. The application may be run on a personal computer, a data input system, a PDA, cell phone or any computing mechanism.

The computer based controller 400 is electrically coupled to the various components that form the molding system or could operate in a wireless manner. The controller 400 is a processor-based unit that operates to orchestrate the forming of the structural parts. In part, the controller 400 operates to control the composite material being deposited on the lower mold by controlling temperature of the composite material, volumetric flow rate of the extruded composite material, and the positioning and rate of movement of the lower mold 230 in the x-direction and position and rate of movement of the adjustable extension barrel 190 in the y-direction to receive the extruded composite material.

The controller is further operable to control the heaters that heat the polymeric materials. The controller may control the rate of the auger 320 to maintain a substantially constant flow of composite material through the barrel to the drop point 340. Alternatively, the controller may alter the rate of the auger 320 to alter the volumetric flow rate of the composite material from the drop point 340. The controller may further control heaters in the barrel.

Based on the structural part being formed, a predetermined set of parameters may be established for applying the extruded composite material to the lower compression mold 230. The parameters may also define how the movement of the lower mold half 230 in the x-direction and movement of the adjustable extension barrel in the y-direction are positionally synchronized with the volumetric flow rate of the composite material in accordance with the cavities on the lower mold that the define the structural part being produced.

Upon completion of the extruded composite material being applied to the lower mold, the controller 400 drives the lower compression mold 230 to the press 130. The controller 400 then signals a mechanism to disengage the wheels from the track 215 so that the press 120 can force the upper mold against the lower mold without damaging the wheels.

The controller 400 may also be configured to support multiple structural parts so that the extrusion-molding system 100 may simultaneously form the different structural parts via the press 130. Because the controller 400 is capable of storing parameters operable to form multiple structural parts, the controller may simply alter control of the drop point 340 and the lower compression mold 230 by utilizing the parameters in a general software program, thereby providing for the formation of two different structural parts using a single drop point. It should be understood that additional presses and lower compression molds (i.e., trolleys) might be utilized to substantially simultaneously produce more structural parts via a single injection head.

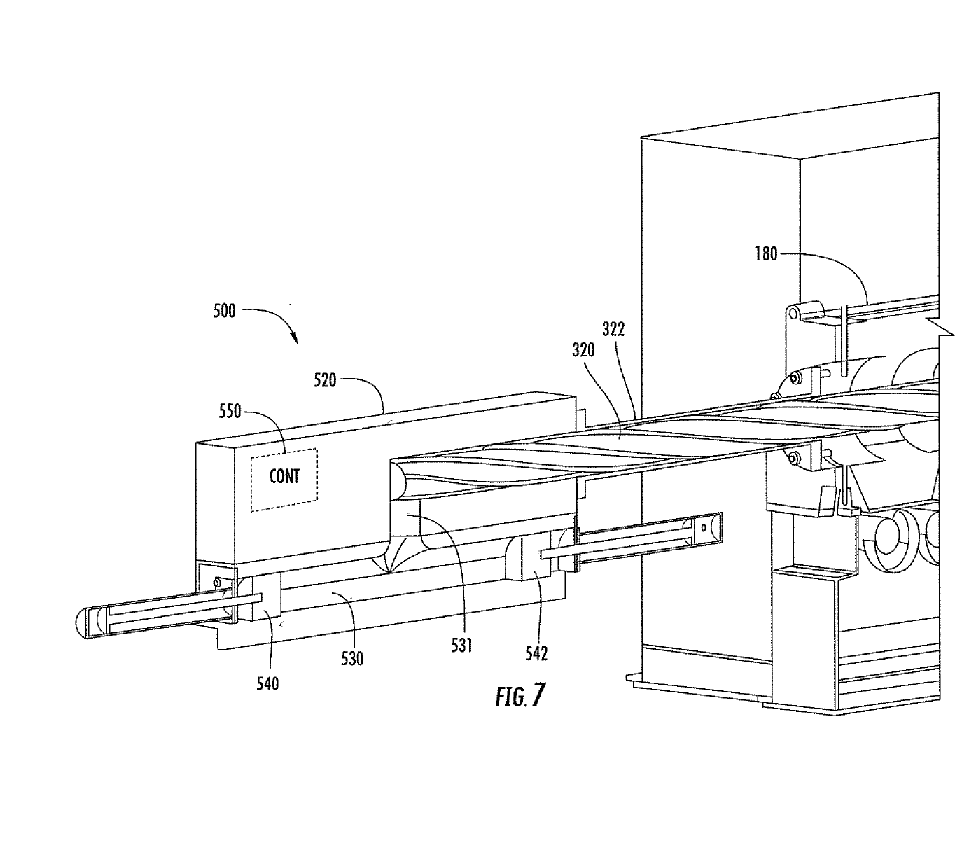

Referring now to FIG. 7, another aspect is directed to a a sheet die apparatus 500 wherein the auger 320 directly interfacing with a sheet die 520 that is part of a sheet die apparatus 500. The illustrated sheet die 520 has a side opening for receiving the auger 320. In other embodiments, the auger 320 may interface the sheet die 520 in a top opening. The sheet die 520 may also be referred to as a hybrid barrel sheet die since the barrel 322 of the extruder 180 is coupled to the sheet die 500.

The sheet die apparatus 500 advantageously does away with the need for a transition pipe that is typically positioned between the extruder 180 and the sheet die 520. A problem arises with extruded material remaining in the transition pipe after having been output from the extruder. When the next batch of molten material is run through the extruder, any material remaining in the transition pipe has to be pushed out through the sheet die. This requires a large amount of torque. Moreover, the molten material can be degraded if it is sheered within the transition pipe as a result of the excess torque. Since the illustrated sheet die apparatus 500 does away with the need for a transition pipe, the above noted problem is no longer an issue.

The auger 320 extends to a center of the sheet die 520 in the illustrated embodiment. In other embodiments, the auger 320 may be received off-center. The extruded material from the auger 320 enters a chamber 530 via a passageway 531 where the molten material then flows therethrough for forming a sheet. The width of the sheet may be varied by changing positioning of the deckling rams or deckles 540, 542. The deckling rams 540, 542 may be a hydraulically press or an air bag press, for example.

A controller 550 carried by the sheet die 520 controls positioning of the deckling rams 540, 542. In other embodiments, the controller 550 is separate from the sheet die 520 itself. As readily appreciated by those skilled in the art, the controller 520 may also operate in cooperation with the extruder 180.

Another advantage of the illustrated sheet die apparatus 500 is that once the extruder 180 is turned off, the deckling rams 540, 542 may be moved toward the center of the chamber 530 to push out any extruded material that may remain in the chamber. This allows the sheet die 520 to be cleaned.

With this particular configuration, if an operator of the sheet die apparatus 500 places 150 pounds of material in the hopper 170, then the operator will know that 150 pounds of material will exit the sheet die 520. For color changes in the molten material, this avoids an overlap of parts with different colors then as initially intended.

Another advantage of the illustrated sheet die apparatus 500 is that heating and power requirements may be reduced. With respect to heating, since the auger 320 is directly in contact with the sheet die 520, there is little time for the material to cool before being formed into a sheet, which means heat loss is not a factor when forming the sheets. Similarly, since heat loss is not a factor, the power requirements to generate the heat for maintaining the molten material can also be more precise.

Another embodiment of the sheet die apparatus 500′ comprises a passageway auger 560′ within the passageway 531′ to push the molten composite material to the chamber 530′. The passageway auger 560′ is vertically positioned so that it protrudes 90 degrees from the top of the sheet die 520′. The passageway auger 560′ is controlled by a motor 562′ carried by the sheet die 520′. The passageway auger 560′ extends within the passageway 531′ so that it receives the molten composite material from the auger 320′. The auger 320′ is positioned so that it stops before the passageway 531′, and an upper portion of the passageway auger 560′ is positioned so that it is level with the output of the auger 320′.

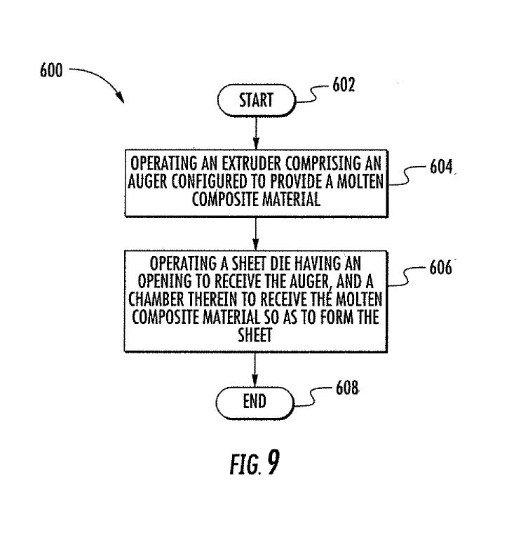

Another aspect is directed to a method of using a sheet die apparatus to form a sheet. Referring now to the flowchart 600 illustrated in FIG. 9, from the start (Block 602), the method comprises operating an extruder 180 comprising an auger 320 configured to provide a molten composite material at Block 604. A sheet die 520 has an opening to receive the auger 320, and a chamber 530 therein to receive the molten composite material so as to form the sheet at Block 606. The method ends at Block 608.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included.

That which is claimed:

1. A sheet die apparatus comprising:
an extruder comprising an auger configured to provide a molten composite material; and
a sheet die having an opening to receive said auger, and a chamber therein to receive the molten composite material so as to form a sheet.

2. The sheet die apparatus according to claim 1 wherein said extruder comprises a barrel enclosing a middle portion of said auger, with an end portion of said auger extending outwards from said barrel and within the opening of said sheet die.

3. The sheet die apparatus according to claim 2 wherein said barrel directly contacts said sheet die.

4. The sheet die apparatus according to claim 1 wherein said sheet die includes a passageway extending between said auger and the chamber for directing the molten composite material.

5. The sheet die apparatus according to claim 4 wherein an end of said auger is positioned within the passageway.

6. The sheet die apparatus according to claim 4 further comprising a passageway auger within the passageway to push the molten composite material to the chamber.

7. The sheet die apparatus according to claim 1 wherein the molten composite material is gravity deposited to the chamber.

8. The sheet die apparatus according to claim 1 wherein said sheet die further comprises at least one adjustable deckle for changing a width of the chamber.

9. The sheet die apparatus according to claim 8 wherein said sheet die includes a passageway extending between said auger and the chamber; and wherein said at least one adjustable deckle comprises a pair of adjustable deckles for changing the width of the chamber to be aligned with a width of the passageway.

10. The sheet die apparatus according to claim 9 wherein the passageway is centered within the chamber.

11. The sheet die apparatus according to claim 1 wherein the molten composite material comprises a matrix component and at least one reinforcement component.

12. The sheet die apparatus according to claim 1 wherein the molten composite material comprises a molten plastic composite.

13. The sheet die apparatus according to claim 12 wherein the molten plastic composite comprises at least one of a thermoset composite and a thermoplastic composite.

14. A sheet die apparatus comprising:
an extruder comprising
an auger configured to provide a molten plastic material, the auger having a middle portion and an end portion, and
a barrel enclosing the middle portion of said auger, with the end portion of said auger extending outwards from said barrel; and
a sheet die having an opening to receive the end portion of said auger, a chamber, and a passageway extending between said auger and the chamber to direct the molten plastic material to the chamber.

15. The sheet die apparatus according to claim 14 wherein said barrel directly contacts said sheet die.

16. The sheet die apparatus according to claim 14 wherein an end of said auger is positioned within the passageway.

17. The sheet die apparatus according to claim 14 further comprising a passageway auger within the passageway to push the molten composite material to the chamber.

18. The sheet die apparatus according to claim 14 wherein said sheet die further comprises at least one adjustable deckle for changing a width of the chamber.

19. The sheet die apparatus according to claim 18 wherein said at least one adjustable deckle comprises a pair of adjustable deckles for changing the width of the chamber to be aligned with a width of the passageway.

20. The sheet die apparatus according to claim 14 wherein the passageway is centered within the chamber.

21. A method for using a sheet die apparatus to form a sheet, the method comprising:
operating an extruder comprising an auger configured to provide a molten composite material; and
operating a sheet die having an opening to receive the auger, and a chamber therein to receive the molten composite material so as to form the sheet.

22. The method according to claim 21 wherein the extruder comprises a barrel enclosing a middle portion of the auger, with an end portion of the auger extending outwards from the barrel and within the opening of the sheet die.

23. The method according to claim 22 wherein the barrel directly contacts the sheet die.

24. The method according to claim 21 wherein the sheet die includes a passageway between the auger and the chamber, and an end of the auger is positioned within the molten composite material passageway.

25. The method according to claim 21 further comprising operating a passageway auger within the passageway to push the molten composite material to the chamber.

26. The method according to claim 21 wherein the sheet die further comprises at least one adjustable deckle; and further comprising operating the at least one adjustable deckle for changing a width of the chamber.
